(19) United States
(12) Patent Application Publication
(10) Pub. No.: US 2004/0228574 A1
(43) Pub. Date: Nov. 18, 2004

(54) Switchable optical dispersion compensator using Bragg-grating

(76) Inventors: Yu Chen, San Jose, CA (US); Jianjun Zhang, Cupertino, CA (US); Peiching Ling, San Jose, CA (US); Jinliang Chen, Saratoga, CA (US); Ming Xu, San Jose, CA (US)

Correspondence Address: PERKINS COIE LLP, PATENT-SEA, P.O. BOX 1247, SEATTLE, WA, 98111-1247, US

(21) Appl. No.: 10/438,665

(22) Filed: May 14, 2003

(51) Int. Cl. G02B 6/26

(52) U.S. Cl. 385/27; 385/37

(57) ABSTRACT

A switchable dispersion compensator comprises an input waveguide for carrying an optical signal having dispersion. Further, a wavelength-selective switch is provided that has a chirped Bragg grating disposed proximate to the input waveguide. The wavelength-selective switch when in an “on” position couples the optical signal into an output waveguide. When the wavelength-selective switch is in an “off” position, the optical signal continues propagating in the input waveguide.

### TECHNICAL FIELD

This invention relates to a dispersion compensator, and more particularly, a switchable dispersion compensator that uses a Bragg grating.

### BACKGROUND

Dispersion is the process by which an optical signal is distorted during transmission due to the differing propagation speeds of different wavelengths in an optical fiber. Dispersion results in a temporal “spreading” of the digital bits, causing interference with adjacent bits.

As data rates increase into the 10 Gb/sec range and higher, dispersion becomes an important concern. Methods for dealing with dispersion include the use of non-zero dispersion shifted fiber (NZDSF) and/or dispersion compensating fiber (DCF). These solutions may be insufficient for high data rates.

Other solutions include the use of transmissive Bragg gratings as illustrated in U.S. Pat. No. 6,501,874 to Frolov et al. Another prior art solution is to use reflective Bragg gratings. However, a reflective Bragg grating dispersion compensator requires an external circulator to direct backward-propagating light from the grating reflections. This causes additional signal strength losses as well as being incompatible with planar integrated optics technology.

Still other solutions include integrated all pass filters, ring resonators, and virtually imaged phased array devices. These and other alternatives are detailed in “Integrated Tunable Fiber Gratings for Dispersion Management in High-Bit Rate Systems”, by Eggleton et al., Journal of Lightwave Technology, Vol. 18, No. 10, October 2000.

### BRIEF DESCRIPTION OF THE DRAWINGS

The nature, advantages and various additional features of the invention will appear more fully upon consideration of the illustrative embodiments now to be described in connection with the accompanying drawings, wherein:

FIGS. 1A to 1F are schematic diagrams showing the on/off switching functions of a switch.

FIGS. 2A to 2B are cross sectional views for showing coupling configurations of a switch coupled between a waveguide and an outbound waveguide.

FIGS. 3A and 3B are functional diagrams for showing a switch that is coupled between the intersecting waveguides for switching and re-directing optical transmission of a selected wavelength.

FIG. 4A illustrates a bridge-beam type switch with integrated Bragg grating element.

FIG. 4B illustrates the cross-sectional structure of a bridge-beam type switch in which the grating coupling is normally off.

FIG. 4C shows the grating element of a bridge-beam type switch in the “on” position.

FIG. 5A illustrates a cantilever-beam type switch with integrated Bragg grating element.

FIG. 5B illustrates the cross-sectional structure of a cantilever-beam type switch in which the grating coupling is normally off.

FIG. 5C shows the grating element of a cantilever-beam type switch in the “on” position.

FIG. 6A illustrates a dual cantilever-beam type switch with integrated Bragg grating element.

FIG. 6B illustrates the cross-sectional structure of a dual cantilever-beam type switch in which the grating coupling is normally off.

FIG. 6C shows the grating element of a dual cantilever-beam type switch in the “on” position.

FIG. 7 illustrates the cross-sectional structure of another embodiment of the grating element.

FIG. 8 illustrates an embodiment where the grating elements are fabricated on both the substrate and the movable beam.

FIG. 9 illustrates an embodiment where the grating elements are fabricated on the horizontal sides of the movable beam.

FIGS. 10A and 10B illustrate a grating element where the waveguides are both fabricated on the same surface of the substrate.

FIG. 11A is an illustration of a chirped grating formed in accordance with the present invention.

FIG. 11B is an alternative embodiment of a chirped grating for dispersion compensation.

FIG. 11C is yet another alternative embodiment of a chirped grating formed in accordance with the present invention.

FIGS. 12A-12B are temperature-induced chirped gratings formed in accordance with the present invention.

FIGS. 13A-13B are strain-induced chirped gratings formed in accordance with the present invention.

FIG. 14 shows the use of chirped gratings at the ends of a bridge waveguide to perform dispersion compensation and switching in accordance with the present invention.

FIG. 15 is a combination of a demultiplexer and dispersion compensator formed in accordance with the present invention.

FIG. 16 is a compact package for demultiplexing and dispersion compensation in accordance with the present invention.

FIG. 17 is a Mach-Zehnder interferometer having chirped gratings that can perform dispersion compensation.

It is to be understood that these drawings are for purposes of illustrating the concepts of the invention and are not to scale.

### DETAILED DESCRIPTION

The present invention discloses a switchable waveguide dispersion compensator using integrated Bragg-grating technology. The dispersion compensator can be integrated with other optical devices, such as demultiplexers, switches, and the like. Further, the dispersion compensator can be manufactured using semiconductor fabrication, planar-lightwave-circuit (PLC), and micro-electromechanical system (MEMS) technology.

In the following description, numerous specific details are provided to provide a thorough understanding of the embodiments of the invention. One skilled in the relevant art will recognize, however, that the invention can be practiced without one or more of the specific details, or with other methods, components, etc. In other instances, well-known structures or operations are not shown or described in detail to avoid obscuring aspects of various embodiments of the invention.

Reference throughout the specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout the specification are not necessarily all referring to the same embodiment. Furthermore, the particular features, structures, or characteristics may be combined in any suitable manner in one or more embodiments.

The first portion of the detailed description will provide information on switchable waveguide technology. The second portion of the detailed description will show how this technology is applied to a dispersion compensator.

Switchable Waveguide Technology

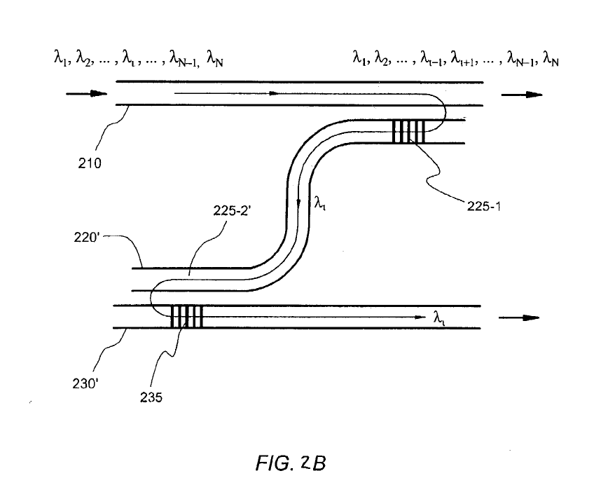

The below description shows many types of switches including switches that do not require “intersection” between an “intersecting” waveguide and an input waveguide. The terms intersecting or intersecting waveguide as used herein are not limited to a physical intersection. Rather any proximal relationship between the “intersecting waveguide” and an input waveguide such that coupling of a desired wavelength channel is accomplished between the input waveguide and “intersecting waveguide”, such as (merely one example) the parallel orientation as shown in FIG. 2A, satisfies the terms intersecting, intersection, or intersecting waveguide.

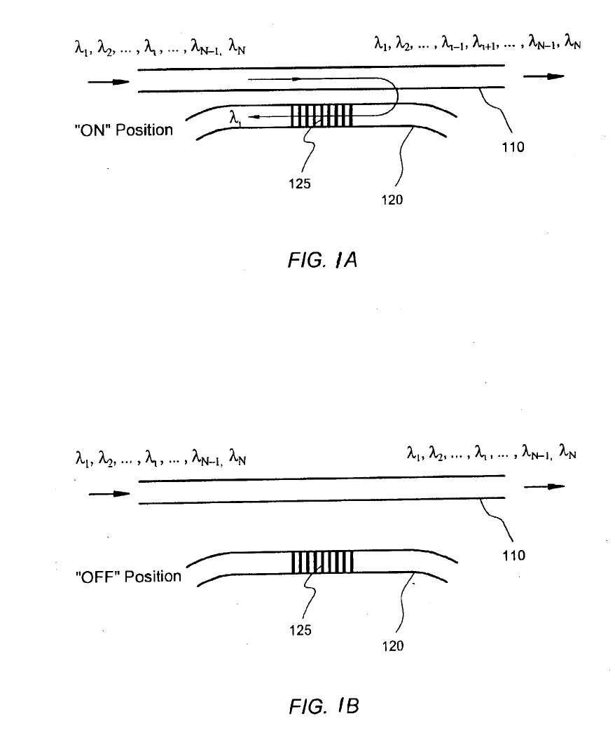

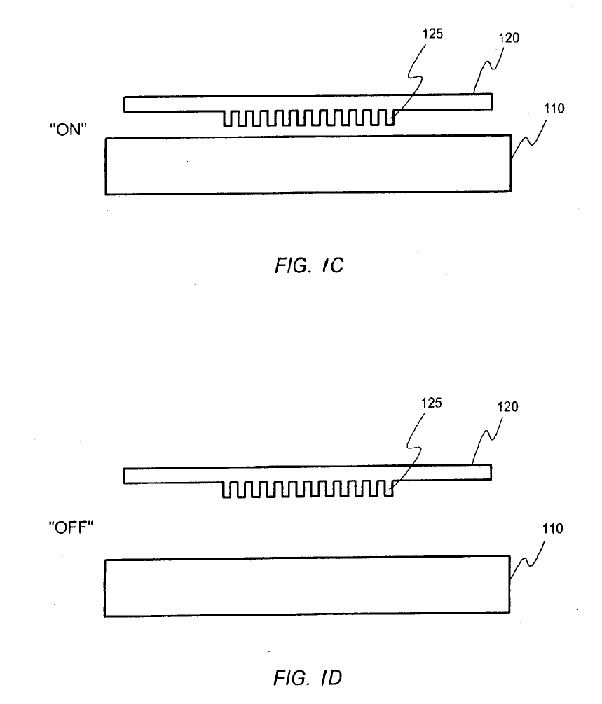

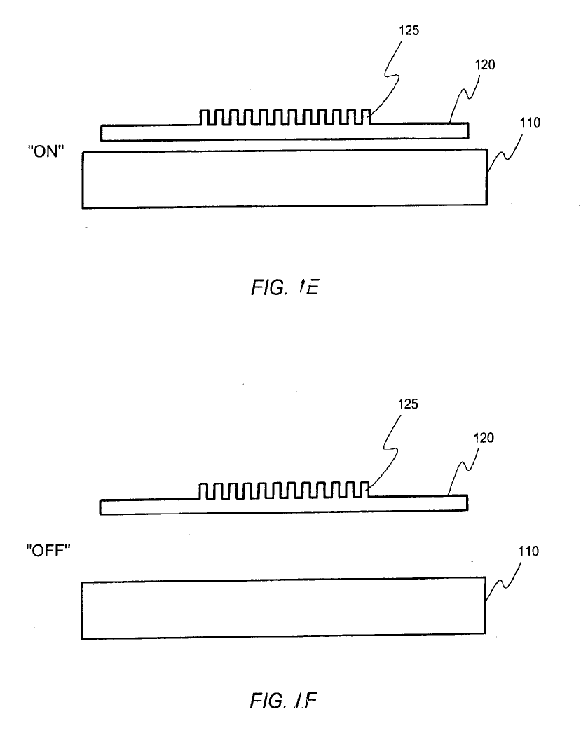

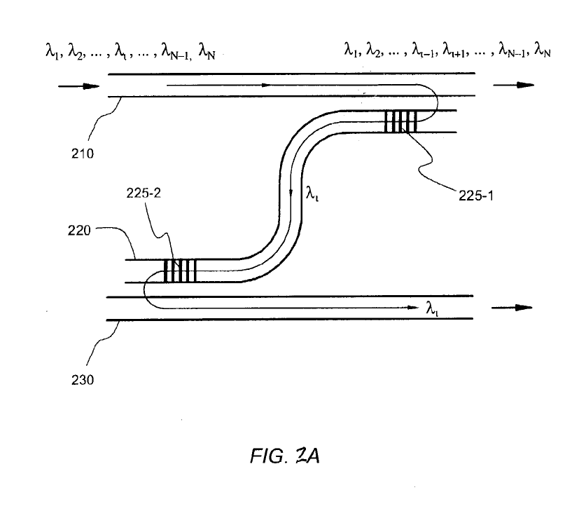

FIGS. 1A and 1B are schematic diagrams for showing the principles of operation of a switch. A multiplexed optical signal is transmitted in an optical waveguide 110 over N multiplexed wavelengths λ1, λ2, λ3, . . . , λN where N is a positive integer. This is a general characterization of a plurality of wavelengths carried by the waveguide 110.

In FIG. 1A, a wavelength selective bridge waveguide 120 is moved to an on-position and coupled to the waveguide 110. An optical signal with a central wavelength λi particular to the, Bragg gratings 125 disposed on the bridge waveguide 120 is guided into the wavelength selective bridge waveguide 120. The remaining wavelengths λ1, λ2, . . . , λi−1, . . . , λi+1, . . . , λN are not affected and continues to propagate over the waveguide 110. The Bragg gratings 125 have a specific pitch for reflecting the optical signal of the selected wavelength λi onto the wavelength selective bridge waveguide 120.

In FIG. 1B, the wavelength selective bridge waveguide 120 is moved away from the waveguide 110 to a “bridge-off” position. There is no coupling between to the waveguide 110 and therefore no “detoured signal” entering into the bridge waveguide 120. The entire multiplexed signal over wavelengths λ1, λ2, λ3, . . . , λN continue to propagate on the waveguide 110.

FIGS. 1C and 1D illustrate a detailed configuration of the Bragg-gratings formed on the wavelength selective bridge waveguide 120. The pitch between the gratings 125 defines a selected wavelength that will be reflected onto the bridge waveguide 120 when the wavelength selective bridge waveguide is at an on-position coupled to the waveguide 110 as that shown in FIG. 1A. Furthermore, as shown in FIGS. 1E and 1F, the Bragg-gratings 125 may be formed on a surface of the bridge waveguide 120 opposite the waveguide 110. Again, as the bridge waveguide 120 is moved to an “on” position coupled to the waveguide 110 in FIGS. 1C and 1E, an optical signal of a selected wavelength defined by the pitch between the Bragg gratings is coupled into the bridge waveguide 120. When the bridge waveguide 120 is moved to an “off” position in FIGS. 1D and 1F, the bridge waveguide 120 is completely decoupled and there is no “detoured signal” into the bridge waveguide 120.

FIG. 2A shows a wavelength selective bridge waveguide 220 coupled between a bus waveguide 210 and a second waveguide 230. A multiplexed optical signal is transmitted in a bus waveguide 210 over N multiplexed wavelengths λ1, λ2, λ3, . . . , λN where N is a positive integer. The wavelength selective bridge waveguide 220 has a first set of Bragg gratings disposed on a first “bridge on-ramp segment” 225-1 for coupling to the bus waveguide 210. An optical signal with a central wavelength λi particular to the Bragg gratings 225 disposed on the bridge waveguide 220 is guided through the first bridge ramp segment 225-1 to be reflected into the wavelength selective bridge waveguide 220.

The remainder optical signals of the wavelengths λ1, λ2, λ3, λi−1, . . . , λi+1, . . . , λN are not affected and continues to transmit over the waveguide 210. The Bragg grating 225 has a specific pitch for reflecting the optical signal of the selected wavelength λi onto the wavelength selective bridge waveguide 220. The wavelength selective bridge waveguide 220 further has a second set of Bragg gratings as a bridge off-ramp segment 225-2 coupled to an outbound waveguide 230. The second set of Bragg gratings has a same pitch as the first set of Bragg gratings. The selected wavelength λi is guided through the bridge off-ramp segment 225-2 to be reflected and coupled into the outbound waveguide 230. The bridge waveguide 220 can be an optical fiber, waveguide or other optical transmission medium connected between the bridge on-ramp segment 225-1 and the bridge off-ramp segment 225-2.

FIG. 2B shows another wavelength selective bridge waveguide 220′ is coupled between a bus waveguide 210 and a second waveguide 230′. A multiplexed optical signal is transmitted in a bus waveguide 210 over N multiplexed wavelengths λ1, λ2, λ3, . . . , λN where N is a positive integer. The wavelength selective bridge waveguide 220′ has a first set of Bragg gratings disposed on a first “bridge on-ramp segment” 225-1 for coupling to the bus waveguide 210. An optical signal with a central wavelength λi particular to the Bragg gratings 225-1 disposed on the bridge waveguide 220′ is guided through the first bridge ramp segment 225-1 to be reflected into the wavelength selective bridge waveguide 220′.

The remainder optical signals of the wavelengths λ1, λ2, λ3, λi−1, λi+1, . . . , λN are not affected and continues to transmit over the waveguide 210. The Bragg gratings 225-1 have a specific pitch for reflecting the optical signal of the selected wavelength λi into the wavelength selective bridge waveguide 220′. The wavelength selective bridge waveguide 220′ further has a bridge off-ramp segment 225-2′ coupled to an outbound waveguide 230′ near a section 235 of the outbound waveguide 230. The section 235 on the outbound waveguide 230′ has a second set of Bragg gratings having a same pitch as the first set of Bragg gratings. The bridge waveguide 220 can be an optical fiber, waveguide or other optical transmission medium connected between the bridge on-ramp segment 225-1 and the bridge off-ramp segment 225-2′.

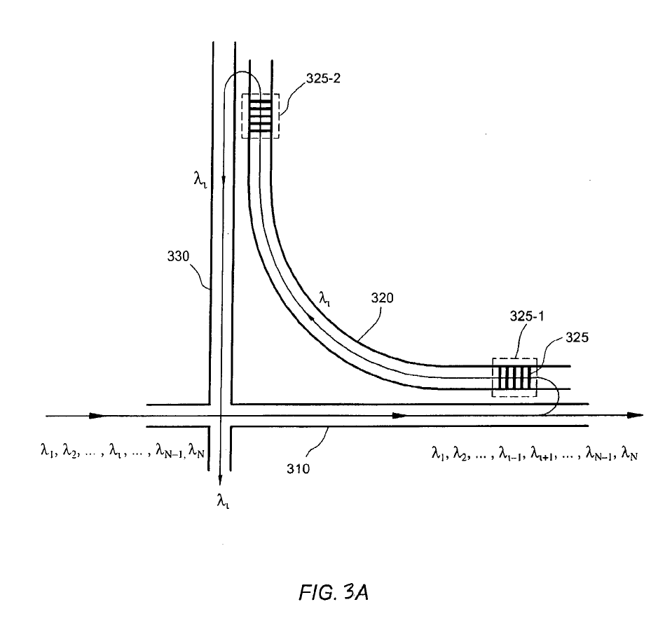

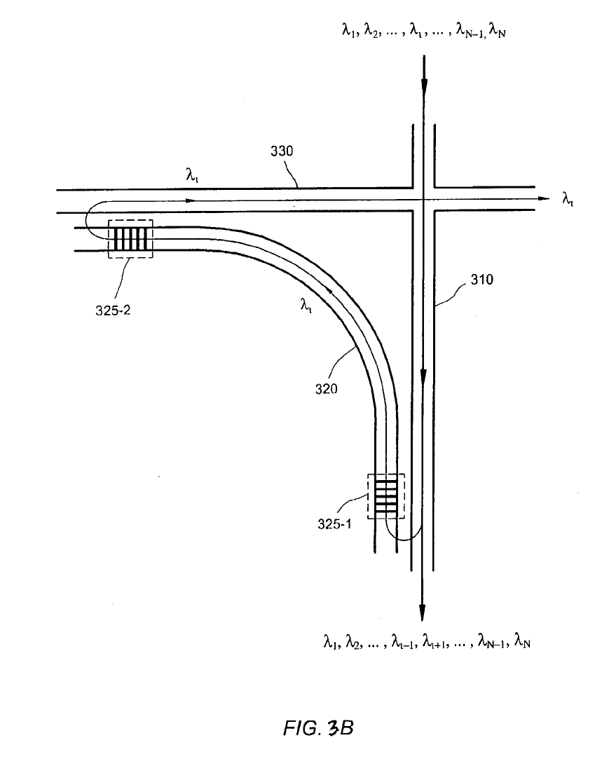

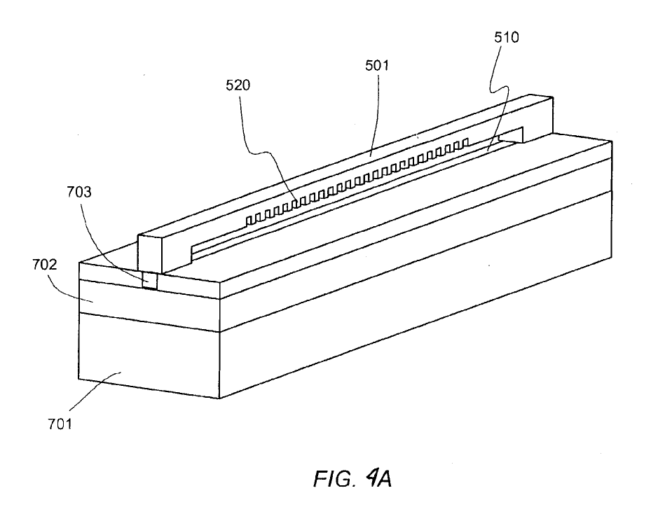

FIG. 3A shows a wavelength selective bridge waveguide 320 is coupled between a bus waveguide 310 and an intersecting waveguide 330. Indeed, the following description shows the operation of the switches 115a-n at the intersection of the input waveguide 111 and the intersecting waveguides 113a-n. A multiplexed optical signal is transmitted in a bus waveguide 310 over N multiplexed wavelengths λ1, λ2, λ3, . . . , λN where N is a positive integer. The wavelength selective bridge waveguide 320 (also referred to as the switch 115 of FIG. 1) has a first set of Bragg gratings disposed on a first “bridge on-ramp segment” 325-1 for coupling to the bus waveguide 310. An optical signal with a central wavelength λi particular to the Bragg gratings 325 disposed on the bridge waveguide 320 is guided through the first bridge ramp segment 325-1 to be reflected into the wavelength selective bridge waveguide 320. The remainder optical signals of the wavelengths λ1, λ2, λ3 . . . , λi−1, λi+1, . . . , λN are not affected and continues to propagate over the waveguide 310.

The Bragg gratings 325 have a specific pitch for reflecting the optical signal of the selected wavelength λi into the wavelength selective bridge waveguide 320. The wavelength selective bridge waveguide 320 further has a second set of Bragg gratings 325 as a bridge off-ramp segment 325-2 coupled to an outbound waveguide 330. The bridge waveguide 320 can be an optical fiber, waveguide or other optical transmission medium connected between the bridge on-ramp segment and the bridge off-ramp segment 325-2.

FIG. 3B is another embodiment with the bus waveguide 310 disposed in a vertical direction and an interesting outbound waveguide 330 disposed along a horizontal direction. As will be seen below, this embodiment of the switch is used in the non-movable bridge waveguide 109.

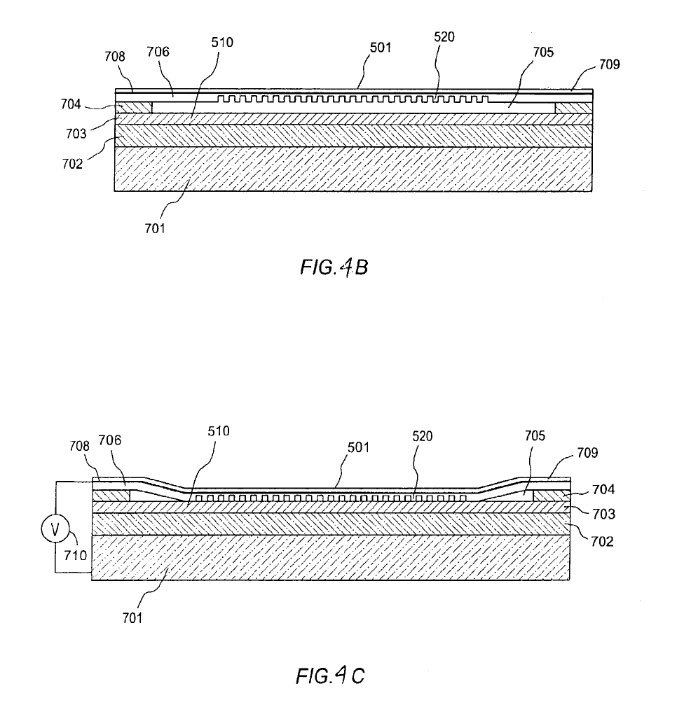

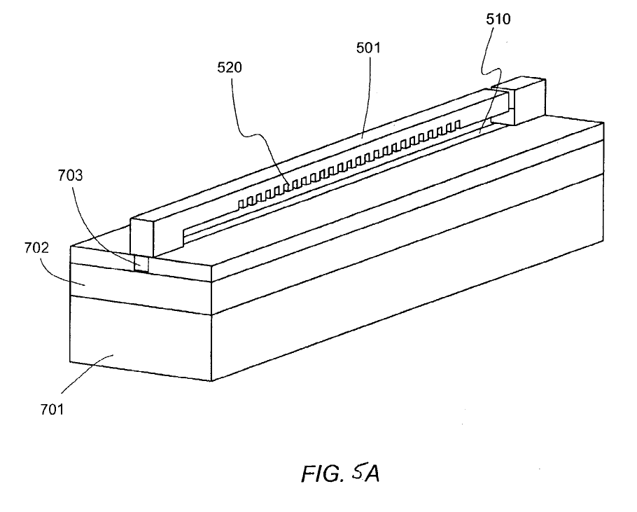

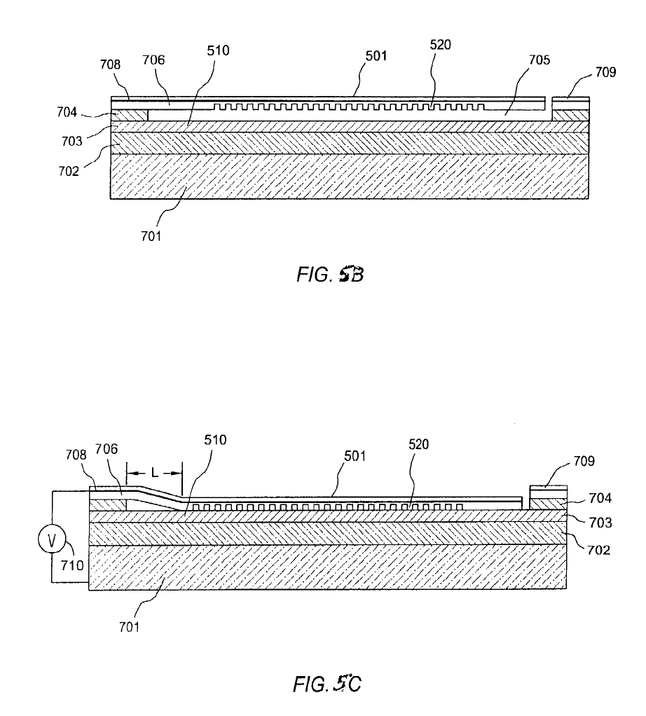

The structures shown in FIGS. 1-3 can be implemented as MEMS devices. For example, FIG. 4A depicts an illustrative embodiment of bridge-beam type switchable grating structure with integrated Bragg grating elements. The structure is fabricated using MEMS technology and semiconductor processing described below. On the substrate 701, a cladding layer 702 is formed first. Then the core layer 703 is deposited and patterned to form waveguide core that is shown more clearly in the cross-sectional view FIG. 4B. The bridge beam 501 is a waveguide consisting of integrated Bragg gratings 520 and an embedded electrode. When this waveguide, called a bridge waveguide, is electrostatically bent close enough to a waveguide 510, the wavelength that meets the Bragg phase-matching condition is coupled into the bridge waveguide. Through the bridge waveguide, the selected wavelength can then be directed into a desired output waveguide.

FIG. 4B shows the cross-sectional view of bridge-beam type switchable grating structure with integrated Bragg grating elements. After the cladding layer 702 and core layer 703 are deposited, a sacrificial layer is deposited after another cladding layer 704 is deposited and patterned. After the sacrificial layer is patterned and the grating grooves are etched on sacrificial layer, another cladding layer 706 is deposited. The electrode layer 708 and the insulation layer 709 are deposited subsequently. The etching process starts from layer 709 through into layer 704 after patterning. Finally the sacrificial layer is etched to form the air gap 705 between waveguide 510 and grating element 520. In an alternative way, the waveguide and the grating element can be fabricated on its own substrate first. Then they are aligned and bonded together to make the same structure shown in FIG. 4B. Due to the existence of air gap 705, the grating is off when the grating element is at normal position (no voltages applied). Referring to FIG. 4C, when an appropriate voltage 710 is applied between the electrode 708 and substrate 701, the grating element 520 is deflected toward waveguide 510 by the electrostatic force. The grating is turned “on” when the grating element 520 moving close enough to input waveguide 510.

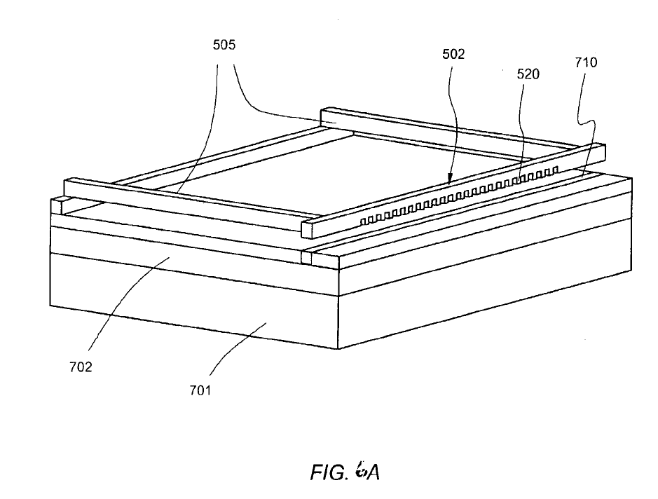

FIG. 5A depicts an illustrative embodiment of cantilever-beam type switchable grating structure with integrated Bragg grating elements. The structure is fabricated using similar MEMS technology and semiconductor processing described above. In this arrangement, the stress and strain in the grating segment 520 can be reduced greatly. Therefore, the lifetime of grating element can be improved. FIG. 5B shows the cross-sectional structure of a cantilever-beam type switch. Referring to FIG. 5C, the cantilever beam 501 is deflected by the electrostatic force. Applying voltages 710 between substrate 701 and electrode 708 controls the electrostatic force applied to the cantilever beam 501. Therefore, by controlling the applying voltages 710 the wavelength-selective optical function can be activated through varying the degree of coupling between Bragg grating 520 and input waveguide 510.

An adequate beam length L is required in order to deflect the beam 501 to certain displacement within the elastic range of the material. For example, a 500 um long cantilever Si beam with the section of 12 um×3 um can be easily deformed by 4 um at the tip of the beam. Another major advantage for the cantilever beam structure is that the movable beam 501 can be shorter and therefore reduce the size of the switch.

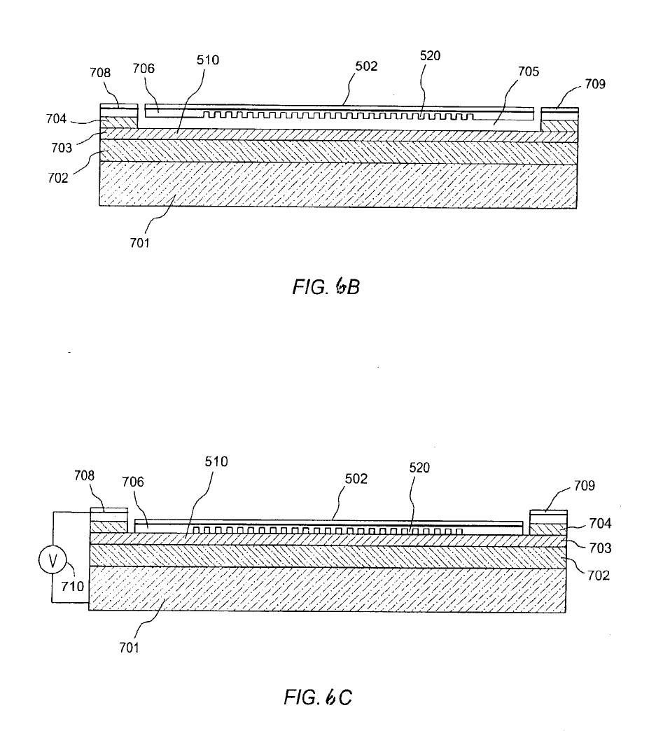

FIG. 6A illustrates another embodiment of the switch. This is a dual cantilever-beam type switch. In this structure the grating element is fabricated on a movable beam 502, which is supported by two cantilever beams 505. In this arrangement, the stress and strain in the grating segment can be eliminated almost completely if the electrode pattern is also located appropriately. Another advantage is that the material of cantilever beams 505 does not necessarily have to be the same as the material of grating element 520. For instance, cantilever beams 505 can be made of metal to improve the elasticity of the beams. In addition, the anchor structure can be in different forms, e.g. MEMS springs or hinges. Therefore, a large displacement and smaller sized grating element is more achievable in this structure. FIGS. 6B and 6C shows the cross-sectional structure of a dual cantilever-beam type switch. Similar to the operations described above, the grating element 520 is moved towards the waveguide 510 by applying voltages 710 to electrode 708 and substrate 701.

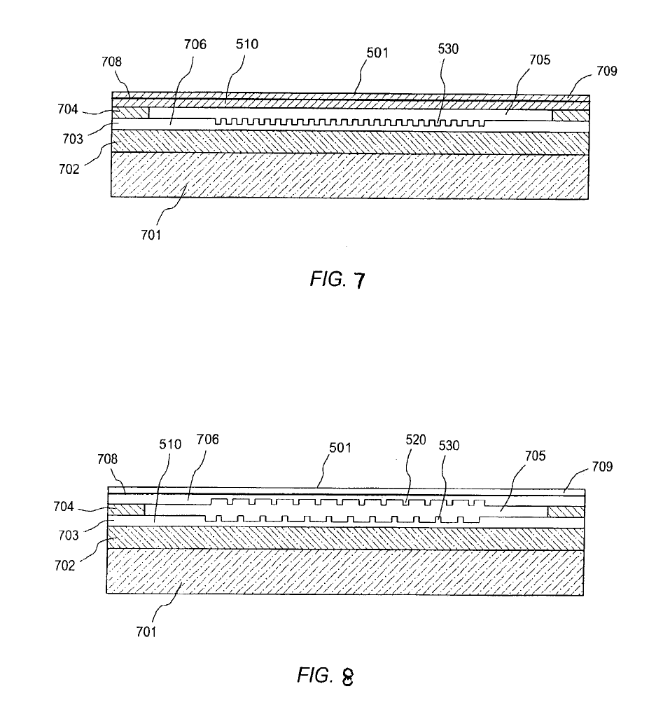

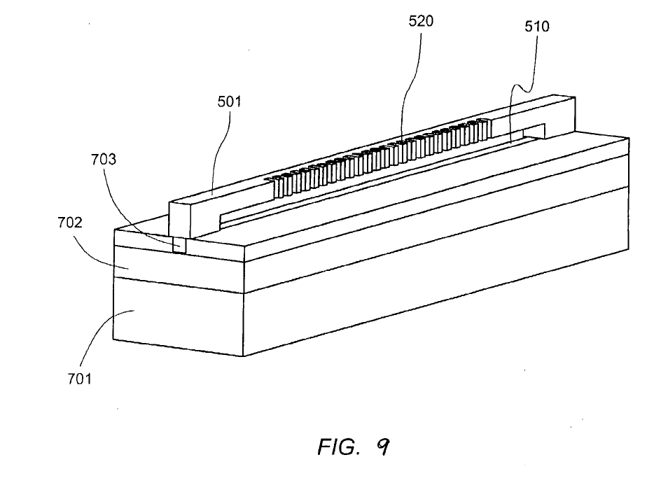

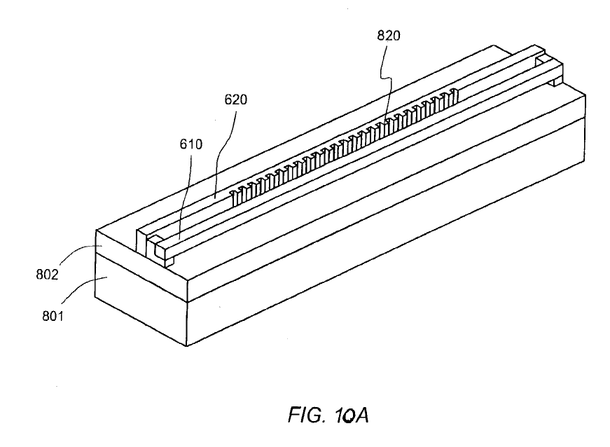

FIG. 7 shows an alternate structure of the grating where the grating is located on the bottom side, or the surface side of the substrate. The structure can be fabricated by applying semiconductor processing technology to form the Bragg gratings 530 on the core layer 703 while positioning the movable beam 501 and the Bragg gratings 530 to have a small gap 705 from the waveguide 510. Similar to the operations described above, an electric conductive layer 708 is formed on the movable beam 501 for applying the voltage to assert an electrostatic force to bend the movable beam 501. The electrostatic force thus activates the movable switch by coupling a waveguide 706 to waveguide 510. The Bragg gratings 530 thus carry out a wavelength-selective optical switch function.

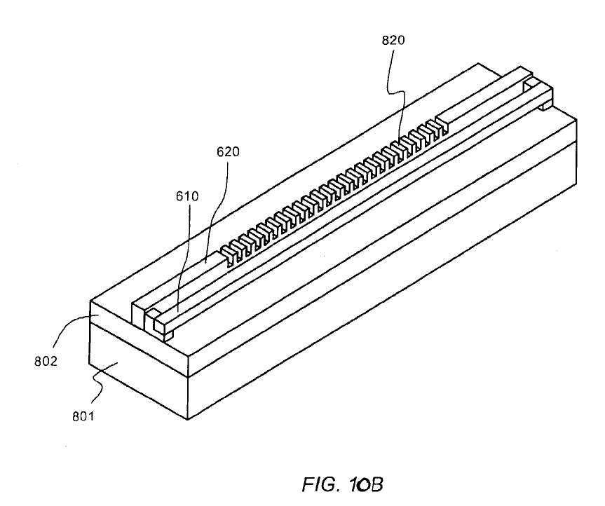

FIG. 8 is also another alternate structure of switchable gratings. In this structure the grating is located on both top and bottom sides. Similar semiconductor processing technology can be used to form the Bragg gratings 520 on the movable beam 501 and the Bragg gratings 530 on the waveguide 510. A small gap is formed between waveguides 510 and 706. An electric conductive layer 708 is also formed on the movable beam 501 for applying the voltage to assert an electrostatic force to bend the movable beam 501. Similar to the operations described above, the electrostatic force thus activates the switch by coupling the selected wavelength from waveguide 510 to waveguide 706.

In the structures described above, the grating element is located faced up or down to the substrate. However, the grating element can also fabricated on the sides of the waveguide, as illustrated in FIG. 9. In this embodiment, the gratings 520 are fabricated on the horizontal sides of the movable beam 501 and the rest of the structure are similar to those structure described above and all the wavelength-selective functions and operations are also similar to those described above. In addition, by rearranging the pattern of the electrode, the grating structure can also be made on the topside of the cantilever or bridge beams. This structure may provide a cost advantage in manufacturing.

FIG. 10A shows another structure of switchable gratings. Instead of arranging the coupling waveguides as several vertical layers supported on a semiconductor substrate as shown above, the coupling waveguides 610 and 620 are formed as co-planar on a same cladding layer 802, supported on a semiconductor substrate 801. The movable waveguide 610 and coupling waveguide 620 have their own embedded electrodes, similar to those described above. Again, the Bragg gratings 820 can be formed on one or both of the waveguides 610 and 620 as described above. When electrostatic voltages are applied between these electrodes, movable waveguide 610 is moved towards waveguide 620 and thus activate the optical switch. FIG. 10B shows another structure with the gratings 820 facing upward.

Application of Waveguide Switches to Dispersion Compensator

The structures shown in FIGS. 1-10 and described above can be adapted for use in conjunction with a dispersion compensator. The detailed description above describes a Bragg-Grating used as a wavelength selective switch. However, by modifying the Bragg-Grating, such as by introducing a chirping, the structure described above can be used as an extremely efficient and cost effective means of dispersion compensation. The term “chirping” or “chirped grating” or other forms thereof is meant to not only cover gratings with variable periodicity, but also any apparatus or means that can impose a chirped functionality into a grating. Examples include temperature or strain induced chirping. Various other techniques such as apodization and tuneability (such as using thermal means) may be used to increase the flexibility of the present invention.

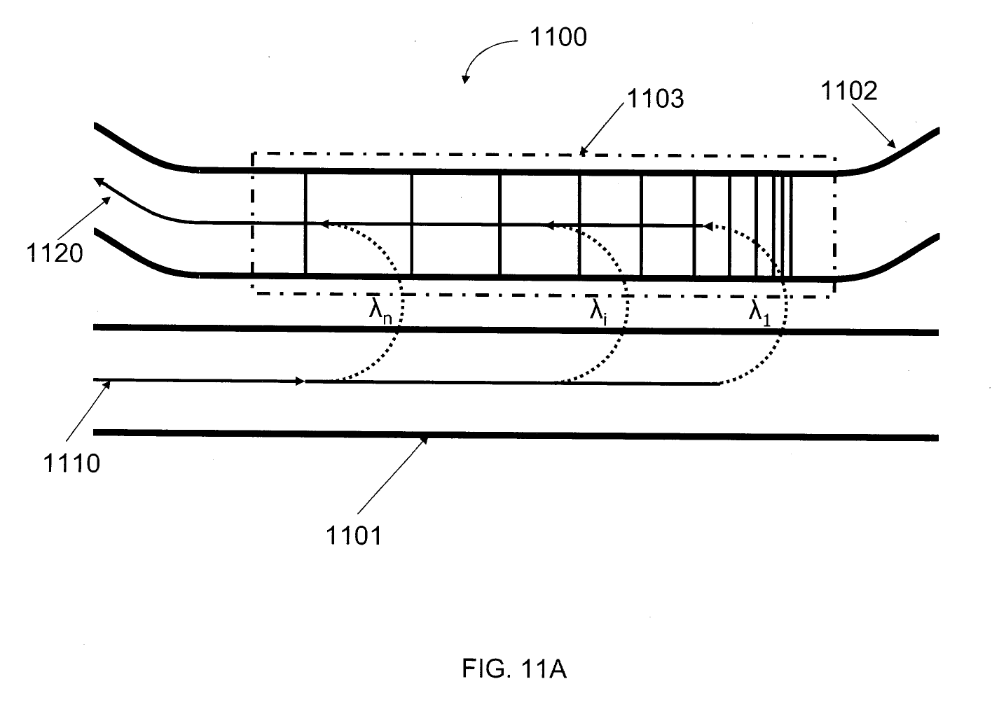

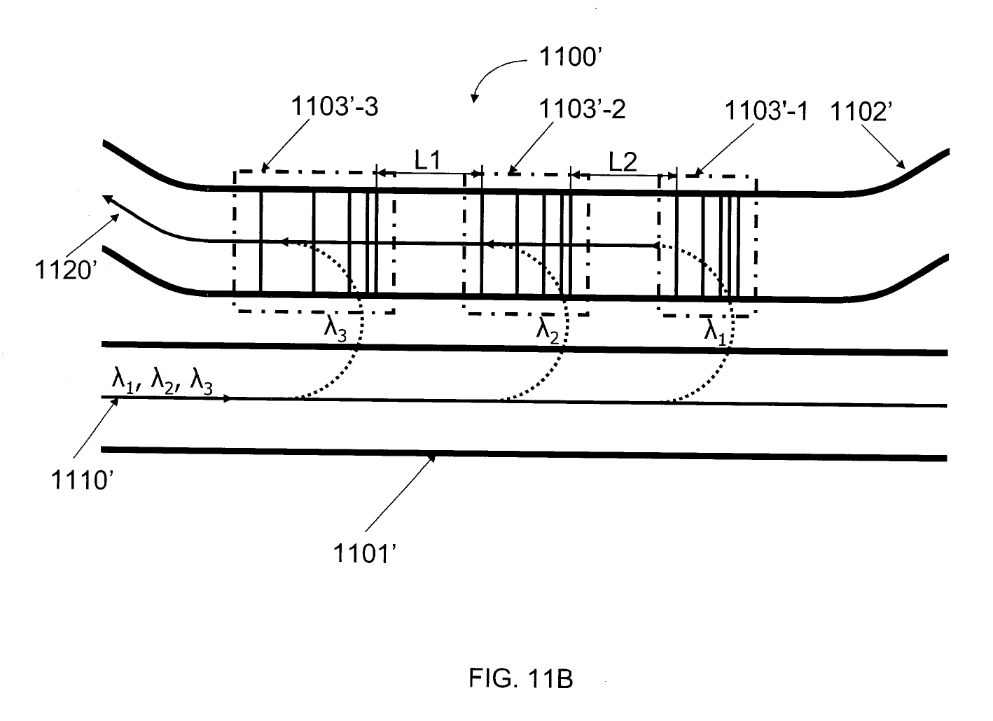

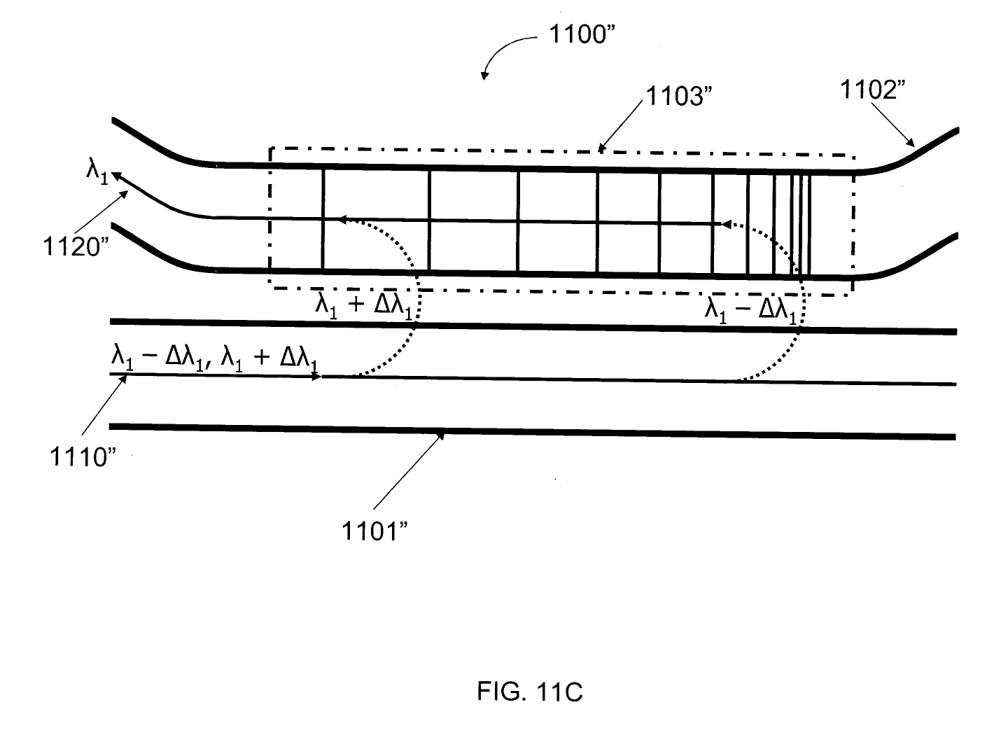

Turning to FIG. 11A, the switching technology described above is adapted to have a chirped grating 1103. The chirped grating has the capability of reflecting different wavelengths at different locations along the grating 1103. This can then be used as a dispersion compensation mechanism. Thus, an input signal 1110 is comprised of λ₁, λ₂, . . . λᵢ, . . . λ_{N}(where λ₁<λ₂<λᵢ<λ_{N}). The input signal 1110 is carried on an input waveguide 1101. A chirped grating 1103 is formed on an output waveguide 1102.

Note that in accordance with one embodiment, the input and output waveguides are formed on an integrated circuit, in contrast to optical fibers that are freestanding and non-integrated. Using this approach, no optical circulator is needed. The reflected dispersion compensated signal exits from the output wave guide 1102 and not from the input wave guide 1101. The characteristics of the chirped grating 1103 is that the longer wavelength optical signals will be reflected and coupled into the output waveguide 1102 earlier and the shorter wavelengths will be coupled “downstream” and reflected later. This is the mechanism by which dispersion compensation is performed.

By integrating the chirped grating with the switching technology described above, several other advantages can be obtained. For example, the coupling between the input waveguide 1101 and the output waveguide 1102 can be done vertically or horizontally. Further, the dispersion compensator is on/off switchable by varying the distance between the input waveguide 1101 and the output waveguide 1102. As already noted above, the distance can be varied by the use of MEMS or other technology. Further, apodization can be combined with the chirped grating 1103 to achieve overall better performance by the suppression of delay ripples.

Another embodiment of the present invention is shown in FIG. 11B. In this embodiment, multiple channels can be dispersion compensated at the same time and with the same structure. In this particular embodiment, three chirped gratings 1103′-3, 1103′-2, and 1103′-1. The input signal 1110′ is carried on the input waveguide 1101′. The compensated output signal 1120′ is carried by the output waveguide 1102′. For each channel, there is an associated chirped grating section. These chirped grating sections 1103′ are separated by “no grating zones” L1 and L2.

The no grating zones are used to ensure that the multiple channels to be reflected are not coupled back into the input waveguide 1101′. In other words, the no grating zones are introduced to adjust the coupling length for different channels to ensure that the channels reflected and coupled into the output waveguide 1102′ are not coupled back into the input waveguide 1101′.

FIG. 11C shows how the chirped grating 1103″ can compensate for dispersion of a single channel. The input waveguide 1101″ carries a single channel λ₁ that has a dispersion of + and −Δλ₁. Thus, the input signal 1110″ has a variety of wavelengths, nominally λ₁, but spread by + and −Δλ₁. The chirped grating 1103″ is designed such that the reflections into the output waveguide 1102″ are arranged such that the output signal 1120″ is not temporally spread.

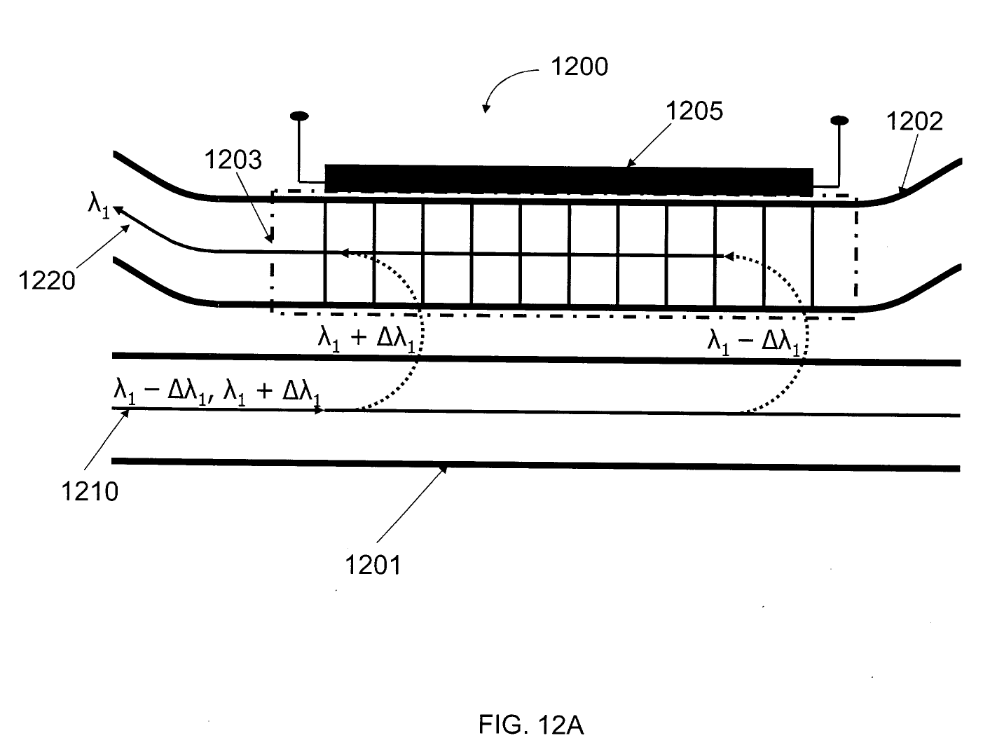

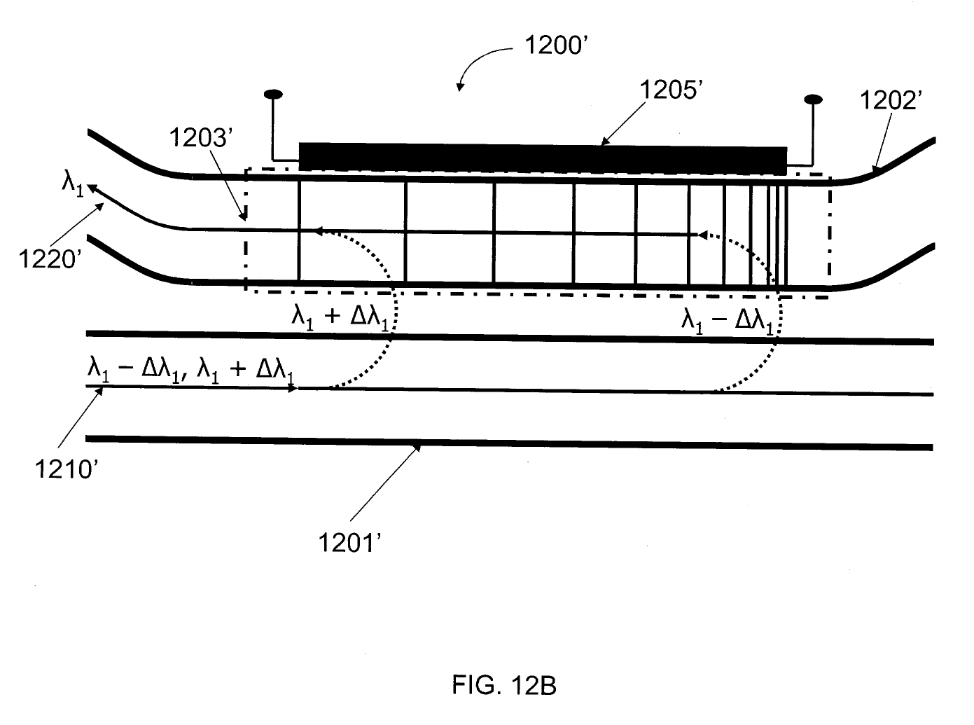

Turning to FIG. 12A, in another embodiment, a uniform grating 1203 is formed on the output waveguide 1202. Further, a heater 1205 is placed in proximity to the uniform grating 1203. The heater is a non-uniform heater 1205 which can induce a temperature gradient along the uniform grating 1203 to cause a chirp in the grating. The use of the heater 1205 allows a chirped grating without having to provide a non-uniform grating.

FIG. 12B shows yet another embodiment which combines a heater 1205′ with a chirped grating 1203′. The advantage of this scheme is that by using the heater 1205′ to provide a temperature gradient on an intrinsically chirped grating 1203′, this dispersion compensator can provide a higher bandwidth compensation with an equivalent amount of input power to the heater 1205′.

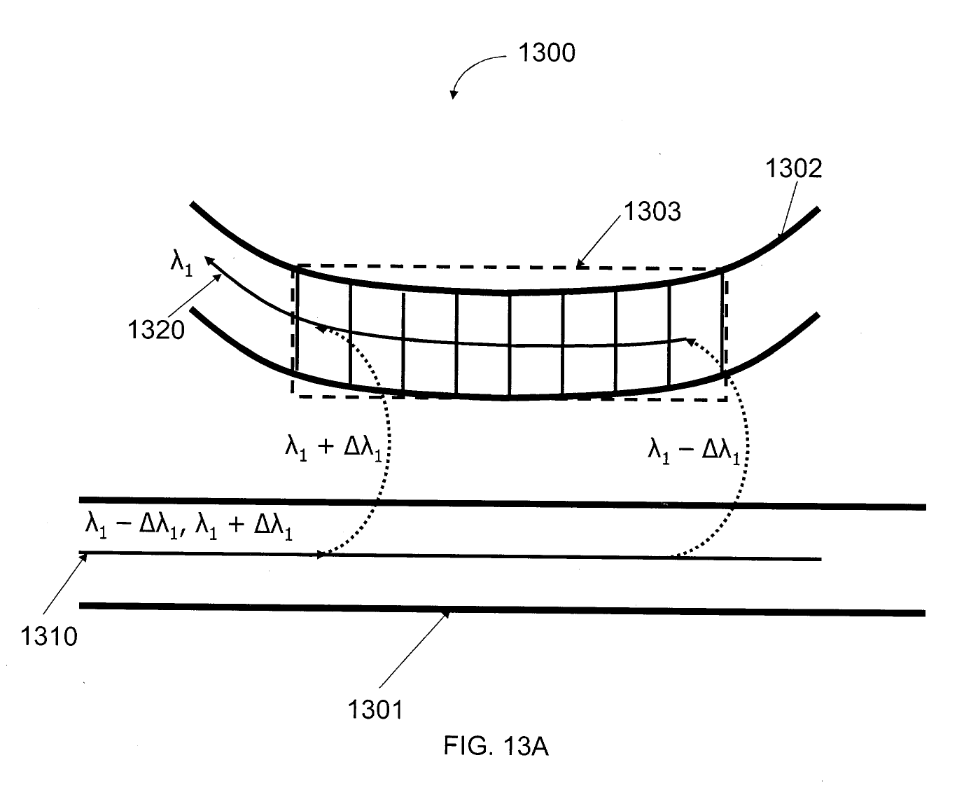

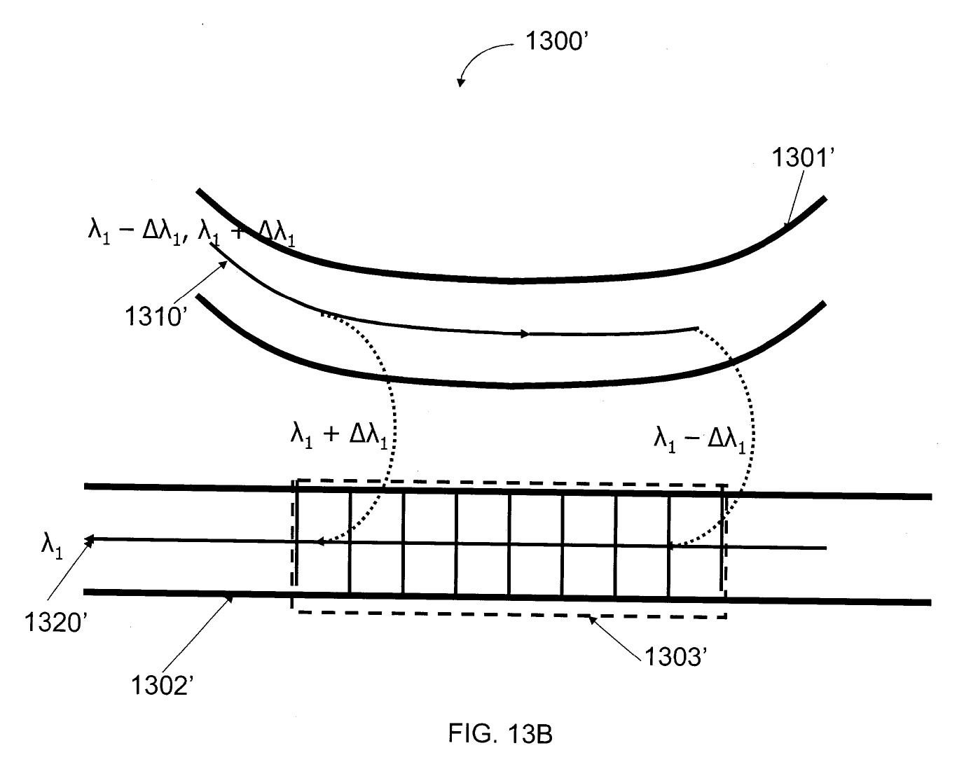

FIG. 13A shows yet another embodiment where a uniform grating 1303 is provided on the output waveguide 1302. However, the output waveguide 1302 is strained to produce a strain-induced chirped grating. This leads to spatial period changes along the length of the grating. The strain grating can be obtained by bending the output waveguide 1302 by, for example, using electrostatic force as described above. One advantage of this embodiment is that a larger tuning range can be provided with a smaller center wavelength shift.

FIG. 13B shows yet another embodiment where the input waveguide 1301′ is curved predeterminently to achieve the same affect of obtaining a chirped grating.

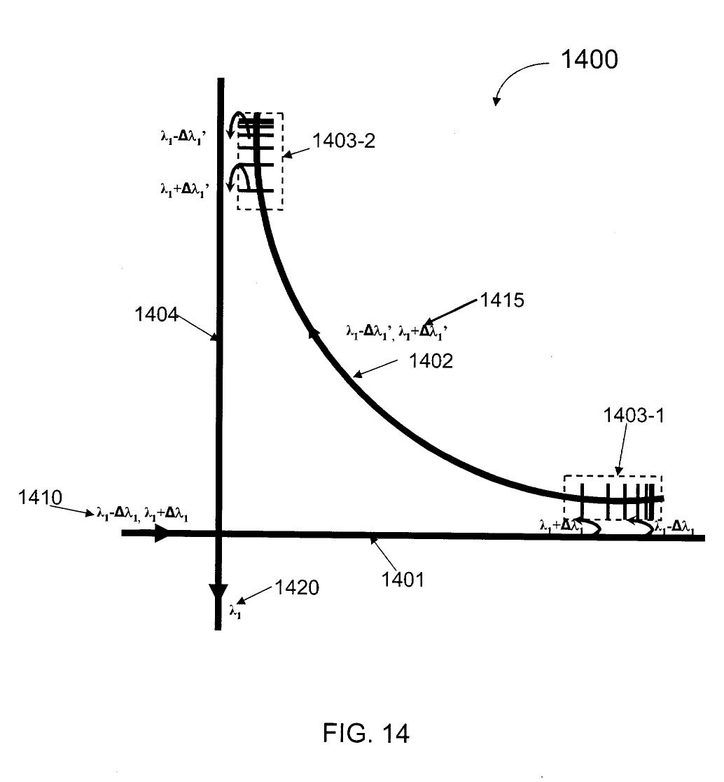

The technology described in FIGS. 1-10 above can further be used to form the embodiment shown in FIG. 14. In this embodiment, an input waveguide 1401 is coupled to a bridge waveguide 1402 that has chirped gratings 1403-1 and 1403-2. Thus, a dispersed input signal 1410 is first compensated by the chirped grating 1403-1 and coupled into the bridge waveguide 1402. The partially compensated signal 1415 is then compensated once again by the chirped grating 1403-2 and reflected into the output waveguide 1404. The first set of chirped gratings 1403-1 is used to partially compensate the dispersion of the input signal 1410. The second set of chirped gratings 1403-2 is used to compensate the residual dispersion in the output signal of the first set of chirped gratings 1403-1. By using two chirped gratings, each of the individual chirped gratings 1403 can be made shorter while still obtaining the desired amount of dispersion compensation. Again, the bridge waveguide 1402 may be made to be on/off switchable and provides functional integration of signal switching and dispersion compensation.

Of course, it can be appreciated that in some embodiments only one of the ends of the bridge waveguide 1402 may have the chirped grating and the other end may simply be a reflection grating. Further, the type of dispersion compensating grating may be any of the types described above, such as a strain induced chirped grating, or a temperature induced chirped grating, or any combination thereof.

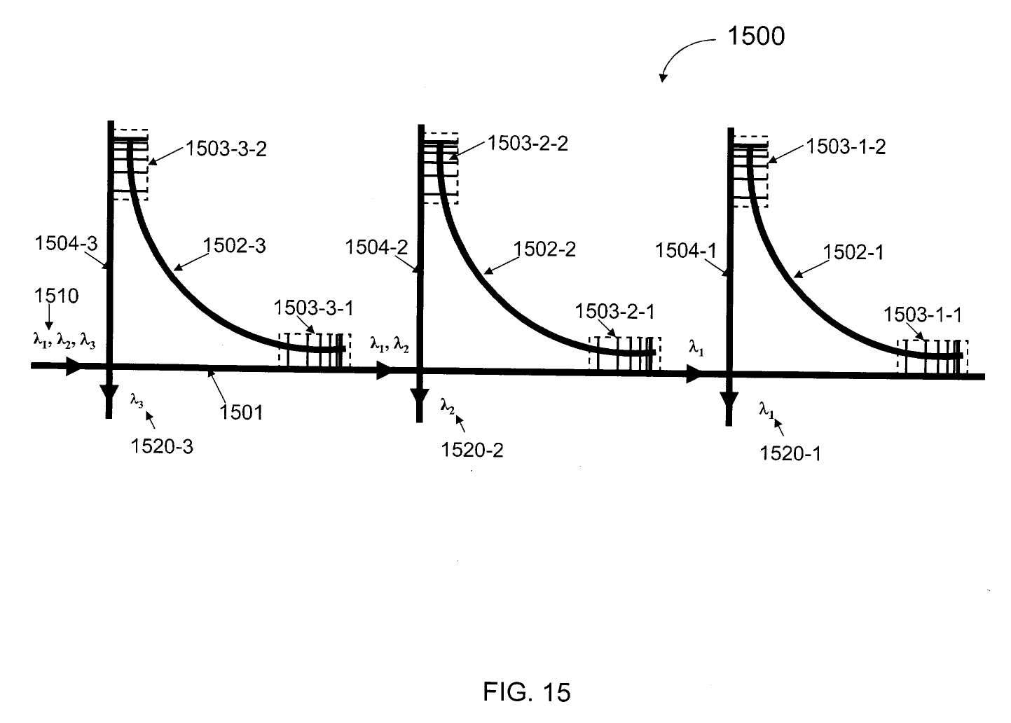

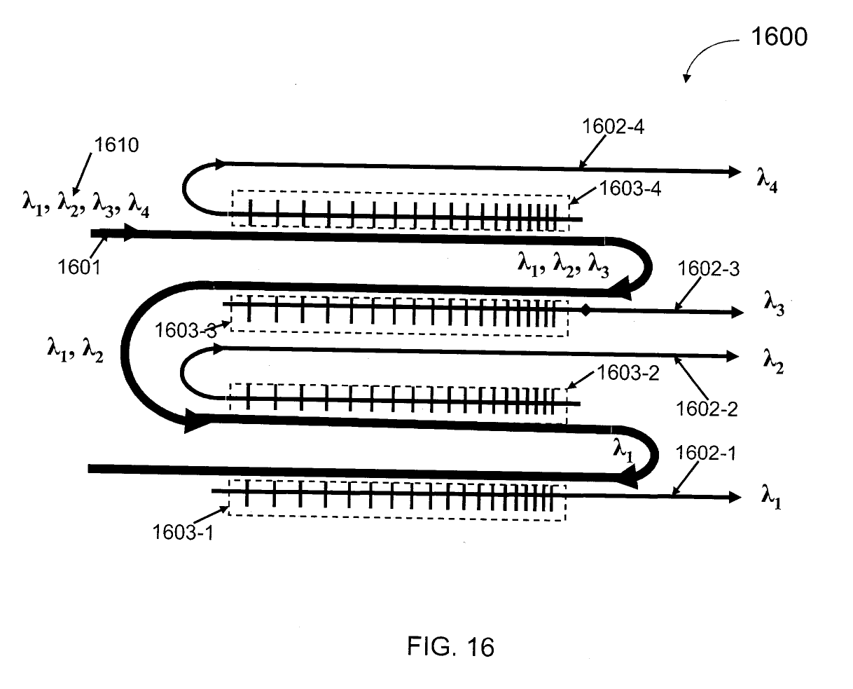

Turning to FIG. 15, the dispersion compensator described above can be used in combination with the switching technology described above to form a demultiplexer. In FIG. 15, an input waveguide 1501 carries an input dispersed signal 1510 that comprises a plurality of wavelengths. Place along and selectively coupled to the input waveguide 1501 are bridge waveguides 1502-3, 1502-2, and 1502-1. One end of the bridge waveguides is coupled to the input waveguide 1501. That end includes chirped grating 1503-3-1, 1503-2-1, and 1503-1-1, respectively. These chirped gratings serve to compensate for the dispersion and reflect a selected wavelength into the bridge waveguides 1502. At the second end of the bridge waveguides 1502, chirped gratings 1503 are used to perform further dispersion compensation and to reflect the appropriate selected signal into the output waveguide 1504. Thus, the apparatus 1500 serves as a dispersion compensator and as a demultiplexer.

It can be appreciated that various other combinations and functionality can be incorporated using the dispersion compensating chirped gratings and the switching technology described above. For example, as disclosed in our co-pending U.S. patent application Ser. No. 10/202,054 entitled “Optical Add/Drop Devices Employing Waveguide Grating-Based Wavelength Selective Switches” and U.S. patent application Ser. No. 10/274,508 entitled “Optical Switch Systems Using Waveguide Grating-Based Wavelength Selective Switch Modules” (both hereby incorporated by reference in their entirety), various types of chirped gratings can be added to these structures described therein to incorporate dispersion compensation with other optical functions. Thus, the present invention can be used to form large scale optical switching and dispersion compensation integrated circuits.

Alternative layouts may be used to save space on the integrated circuit.

For example, as shown in FIG. 16, a serpentine input waveguide 1601 can be used in connection with a plurality of output waveguides 1602-1, 1602-2, 1602-3, and 1602-4. Each of these output waveguides includes a chirped grating 1603-1, 1603-2, 1603-3, and 1603-4. This arrangement provides for a combination dispersion compensator and demultiplexer and a relatively compact package.

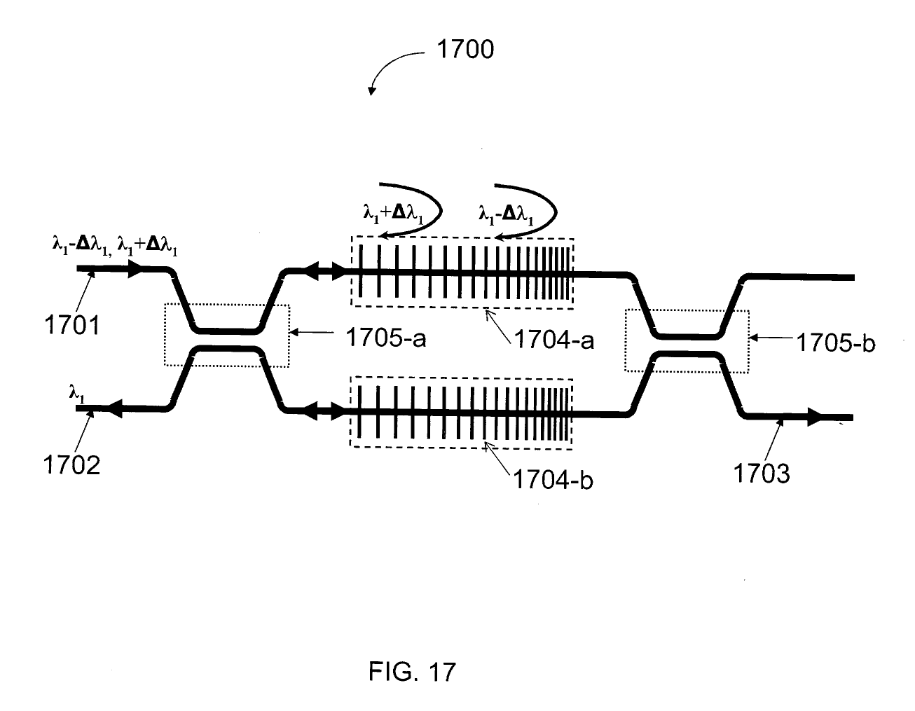

The embodiment of FIG. 17 will next be described. A Mach-Zehnder interferometer is a device that has two separate optical paths (input waveguide 1701 and output waveguide 1702) joined to each other at two joinder points 1705-a and 1705-b. Each optical path may be a fiber or planar waveguide. One joinder point may be used as an input port at which an input optical signal originally in either one optical path is received and split into two equal optical signals separately in the two optical paths.

Accordingly, the other joinder point 1705-b at the opposite sides of the optical paths may be used as the output port at which the two optical signals, after propagating through the two separate optical paths, are combined to interfere with each other. This device is a 4-terminal device with two inputs and two outputs.

In such a Mach-Zehnder interferometer, each of the input and output joints can be formed by overlapping the two optical paths over a region with a desired coupling length to allow for energy coupling therebetween so that it is essentially a 3-dB directional coupler (1705-a and 1705-b).

By incorporating a chirped grating in the optical waveguides between the two couplers, dispersion compensation can be performed. Specifically, two identical waveguide arms connect two identical 3 dB directional couplers 1705A and 1705B. For multiple wavelength inputs, one wavelength (the drop channel) will appear at one output port (for example output port 1702). All of the other wavelengths will exit at the other output port 1703. The 3 dB couplers 1705A and 1705B can be direct couplers, multi-mode interferometers, and the like. This embodiment provides functionality integration of signal filtering and dispersion compensation. Of course, the chirped gratings 1704-A and 1704-B can be replaced by a temperature induced chirped grating, or a strain induced chirped grating, or any combination thereof. Further, the embodiment shown in FIG. 17 can be combined in various manners to incorporate demultiplexing and dispersion compensation into a single integrated circuit.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

We claim:

1. An apparatus comprising:
an input waveguide for carrying an optical signal having dispersion; and
a wavelength-selective switch having a chirped Bragg grating disposed proximate to said input waveguide, said wavelength-selective switch when in an “on” position coupling said optical signal into an output waveguide, said wavelength-selective switch when in an “off” position allowing said optical signal to continue propagating in said input waveguide.

2. The apparatus of claim 1 wherein said wavelength-selective switch comprises a movable coupling switching means for coupling to said input waveguide.

3. The apparatus of claim 1 wherein said wavelength-selective switch includes a movable coupling waveguide and said chirped Bragg grating is implemented as a variable period grating.

4. The apparatus of claim 1 wherein said wavelength-selective switch includes a movable coupling waveguide and said chirped Bragg grating is implemented as a uniform grating having means for applying a temperature gradient to said uniform grating.

5. The apparatus of claim 1 wherein said wavelength-selective switch includes a movable coupling waveguide and said chirped Bragg grating is implemented as a uniform grating having means for applying a strain gradient to said uniform grating.

6. The apparatus of claim 1 wherein said chirped Bragg grating is comprised of a plurality of chirped sub-gratings separated by no grating zones.

7. The apparatus of claim 1 wherein said chirped Bragg grating is an apodized chirped Bragg grating.

8. The apparatus of claim 3 further including means for applying a temperature gradient to said Bragg grating.

9. A wavelength-selective planar light-wave circuit comprising:
an optical switch for routing optical signals from an integrated input waveguide to an output waveguide, wherein said optical switch is a movable beam having a chirped Bragg grating, further wherein said input waveguide and said output waveguide are proximal to each other and wherein the chirped Bragg grating can act to wavelength-selectively to alter the passage of an optical signal from the input waveguide to the output waveguide.

10. The apparatus of claim 9 wherein said chirped Bragg grating is implemented as a variable period grating.

11. The apparatus of claim 9 wherein said chirped Bragg grating is implemented as a uniform grating having means for applying a temperature gradient to said uniform grating.

12. The apparatus of claim 9 wherein said chirped Bragg grating is implemented as a uniform grating having means for applying a strain gradient to said uniform grating.

13. The apparatus of claim 9 wherein said chirped Bragg grating is comprised of a plurality of chirped sub-gratings separated by no grating zones.

14. The apparatus of claim 9 wherein said chirped Bragg gratings is an apodized chirped Bragg grating.

15. A dispersion compensator comprising:
an input waveguide carrying an optical signal;
an output waveguide;
a switchable bridge waveguide having a first end and a second end, said first end having a chirped Bragg grating for coupling said optical signal into said bridge waveguide while compensating for dispersion in said optical signal, said second end having a Bragg grating for coupling said optical signal in said bridge waveguide into said output waveguide.

16. The dispersion compensator of claim 15 wherein said chirped Bragg grating on said first end of said bridge waveguide is an apodized chirped Bragg grating.

17. The dispersion compensator of claim 15 wherein said Bragg grating on said second end of said bridge waveguide is chirped.

18. The dispersion compensator of claim 15 wherein said Bragg grating on said second end of said bridge waveguide is an apodized Bragg grating.

19. The dispersion compensator of claim 15 wherein said input waveguide carries a plurality of channels of optical signals and said bridge waveguide is adapted to couple one of said plurality of channels as said optical signal.

20. A dispersion compensator comprising:
an input waveguide carrying an optical signal;
an output waveguide;
a switchable bridge waveguide having a first end and a second end, said first end having a Bragg grating for coupling said optical signal into said bridge waveguide, said second end having a chirped Bragg grating for coupling said optical signal in said bridge waveguide into said output waveguide while compensating for dispersion in said optical signal.

21. The dispersion compensator of claim 20 wherein said input waveguide carries a plurality of channels of optical signals and said bridge waveguide is adapted to couple one of said plurality of channels as said optical signal.

22. The dispersion compensator of claim 20 wherein said chirped Bragg grating is an apodized chirped Bragg grating.

23. A demultiplexing dispersion compensator comprising:
an input waveguide carrying a plurality of optical channels;
a plurality of output waveguides each associated with a one of said plurality of optical channels, each output waveguide having an chirped Bragg grating designed to couple its associated optical channel.

24. The compensator of claim 23 wherein said output waveguides are switchable into an on position such that its associated optical channel is coupled and switchable into an off position such that its associated optical channel is not coupled.

25. The compensator of claim 23 wherein said chirped Bragg grating on said each output waveguide is an apodized chirped Bragg grating.

26. A Mach-Zehnder interferometer based disperson compensator, comprising:
a first waveguide for carrying an input optical signal;
a second waveguide having an optical path joined to the first waveguide at a first and second joinder locations;
a first coupler formed at the first of the joinder locations, the first coupler configured to receive the input optical signal and split the input optical signal into a first optical signal propagating in said first waveguide and a second optical signal in said second waveguide; and
an second coupler formed at the second of said joinder locations and configured to combine said first and said second optical signals to cause optical interference therebetween,
wherein between said first coupler and said second coupler, said first waveguide has a first chirped Bragg grating and said second waveguide has a second chirped Bragg grating.

27. The dispersion compensator of claim 26 wherein said first chirped Bragg grating has the same reflecting characteristics as said second chirped Bragg grating.

28. The dispersion compensator of claim 26 wherein said chirped Bragg grating is implemented as a uniform grating having means for applying a temperature gradient to said uniform grating.

29. The dispersion compensator of claim 26 wherein said chirped Bragg grating is implemented as a uniform grating having means for applying a strain gradient to said uniform grating.

30. The dispersion compensator of claim 26 wherein said chirped Bragg grating is an apodized chirped Bragg grating.

31. The dispersion compensator of claim 28 further including means for applying a temperature gradient to said Bragg grating.
